(19) United States
(12) Patent Application Publication
(10) Pub. No.: US 2009/0041358 A1
(43) Pub. Date: Feb. 12, 2009

(54) Information storage apparatus and travel environment information recognition apparatus

(75) Inventors: Hiromichi Tanaka, Tokai-city (JP); Minoru Okada, Gifu-city (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 12/221,931

(22) Filed: Aug. 7, 2008

(30) Foreign Application Priority Data
Aug. 10, 2007 (JP) 2007-210274

(51) Int. Cl. G06K 9/46

(52) U.S. Cl. 382/195

(57) ABSTRACT

An information storage apparatus recognizes a traffic sign on a road expressed by a road surface image, and stores recognized traffic sign in association with its position information in a hard disk drive. By recognizing and storing information on the traffic sign in combination with the position information for the sake of traffic safety, information coverage in terms of traffic safety is updated to the most up-to-date condition for roads in the entire country.

### CROSS REFERENCE TO RELATED APPLICATION

The present application is based on and claims the benefit of priority of Japanese Patent Application No. 2007-210274 filed on Aug. 10, 2007, the disclosure of which is incorporated herein by reference.

### FIELD OF THE INVENTION

The present disclosure generally relates to an information storage apparatus that stores traffic sign information that represents traffic regulations and instructions, and an apparatus for recognizing travel environment information in association with the information storage device.

### BACKGROUND INFORMATION

Conventionally, surface images pictured from above the roads by satellites, airplanes or the like is used to recognize traffic signs (sign boards) on raised structures. For example, Japanese patent document JP-A-2006-178694 discloses a device for recognizing the sign and storing the position of the traffic sign.

On the other hand, map information for representing a road map usually includes traffic environment information for the entire country, thereby constituting a huge volume of map information. However, because of its hugeness, collecting information from ever changing environment and updating the information regarding traffic safety to the most recent condition for the entire country is nearly impossible

None the less, map users request map makers to keep up to the changing environment. Therefore, the map makers make great efforts to survey the environment and to confirm the measurement result, only to increase the map making costs. As a result, it is very difficult for the map makers to only maintain the map information of road connections mainly used for route guidance. As a matter of fact, the information required for traffic safety is not catching up the current condition for the entire road network in the country.

Further, the traffic signs on the raised structure recognized by a method disclosed in the above patent document mainly include route guidance information in many cases, and the actual contents type of the traffic signs is not recognized in the above-described method.

Therefore, the contents of the traffic signs have to be checked by actually visiting the site. Thus, the information required for the traffic safety is not possibly be updated for the road in the entire country.

### SUMMARY OF THE INVENTION

In view of the above and other problems, the present disclosure provides an apparatus that enables information required for traffic safety to be stored and to be kept up to the most recent condition for the entire roads in the county.

The information storage apparatus, as an aspect of the invention, includes: a road image storage for storing a road image; a traffic sign recognition unit for recognizing traffic sign information derived from a traffic sign painted on a road based on the road image stored in the road image storage unit; and a traffic sign information storage for storing the traffic sign information recognized by the traffic sign recognition unit in association with position information that locates a location of the traffic sign information. The traffic sign recognition unit recognizes the traffic sign information existing on a road that is expressed by the road image.

The traffic sign includes information required for traffic safety such as, for example, a stop line, a pedestrian crossing or the like. Therefore, the present invention enables the information required for traffic safety to be kept up to the most recent condition for the roads in the entire country based on the recognition of the traffic signs derived from the road image and storage of the recognized traffic signs in the traffic sign storage.

Further, by having the information storage apparatus of the present invention in a vehicle, the driver of the vehicle can utilize the traffic sign information for travel control of the vehicle, warning control of the vehicle or the like, thereby making the travel of the vehicle much safer.

### BRIEF DESCRIPTION OF THE DRAWINGS

Other objects, features and advantages of the present invention will become more apparent from the following detailed description made with reference to the accompanying drawings, in which:

FIG. 1 is a block diagram showing the composition of a car navigation equipment in an embodiment of the present invention;

FIG. 2 is a diagram explaining the template information in the embodiment;

FIG. 3 is a flow chart showing a traffic-sign-painted-on-the-road information registration processing performed by a control unit;

FIG. 4 is a flow chart showing a travel control processing performed by the control unit;

FIG. 5 is a diagram showing an operation performed in a travel control processing;

FIG. 6 is a block diagram showing a composition of the car navigation equipment and an information center in another embodiment;

FIG. 7 is a flow chart showing a traffic-sign-painted-on-the-road information registration processing by the control unit;

FIG. 8 is a flow chart showing a traffic-sign-painted-on-the-road information request processing by the control unit;

FIG. 9 is a flow chart showing a traffic-sign-painted-on-the-road information registration processing by the control unit; and

FIG. 10 is a flow chart showing a traffic-sign-painted-on-the-road information provision processing by the control unit.

### DETAILED DESCRIPTION

### First Embodiment

In the present embodiment, a car navigation equipment in a vehicle having the information storage apparatus concerning the present invention is explained with reference to the drawing. In addition, the car navigation equipment is for concurrently displaying the current position of the vehicle together with a road map on a display screen along the travel of the vehicle, or guiding the course from the current position to the destination which the vehicle crew member set up.

1. Composition of the Car Navigation Equipment 1

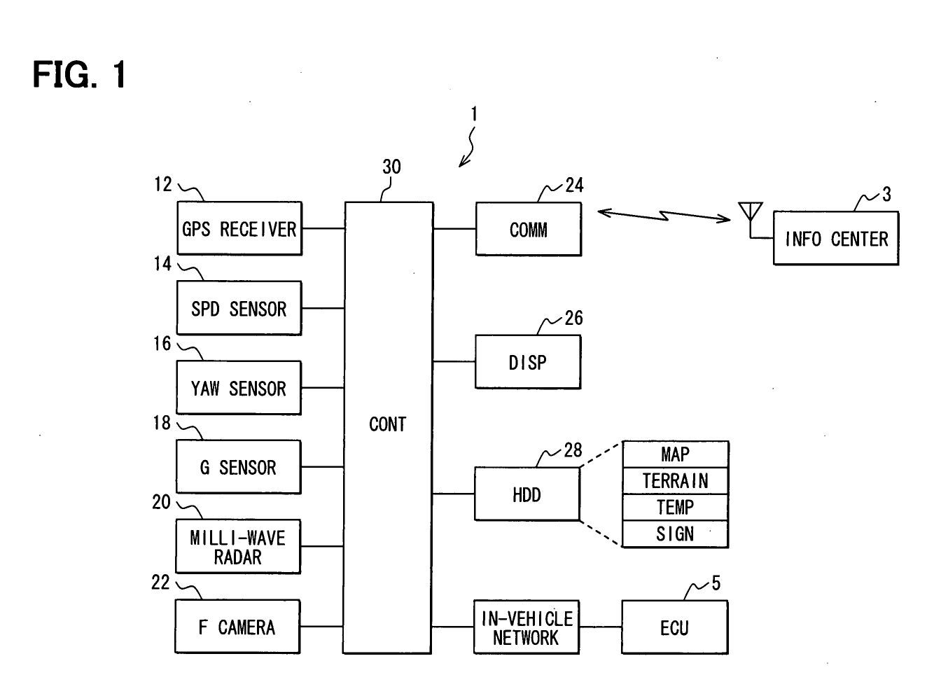

FIG. 1 is a block diagram showing the composition of a car navigation equipment 1 concerning the present embodiment. The car navigation equipment 1 includes, as shown in FIG. 1, a GPS (Global Positioning System) receiver 12, a speed sensor 14, a yaw rate sensor 16, a G sensor 18, a millimeter wave radar 20, a front camera 22, a radio communications unit 24, a display unit 26, a hard disk drive (HDD) 28, and a control unit 30, and the like.

The GPS receiver 12 receives the transmission radio wave from the artificial satellite for GPS through a GPS antenna, and detects the current position and speed of the vehicle, and the speed sensor 14 detects the travel speed of the vehicle.

The yaw rate sensor 16 detects a yaw rate showing the turning state of the vehicle, and the G sensor 18 detects the acceleration in a front and rear, right and left direction of the vehicle. The millimeter wave radar 20 measures the distance and the direction to an object in the predetermined domain of the vehicle circumstance. The front camera 22 pictures a range ahead of the vehicle, and the front camera 22 is attached in a front part of the vehicle.

The radio communications unit 24 communicates with an information center 3 by radio, and the car navigation equipment 1 of the present embodiment acquires a variety of information based on the communication performed between the radio communications unit 24 and the information center 3.

In the present embodiment, the photograph of the road (surface of the earth) pictured from the sky above the surface of the earth by the artificial satellite (designated henceforth as a surface-of-the-earth picture) is registered and managed by the information center 3, and the surface-of-the-earth picture is pictured for every section which divides an entire area of the country into plural portions.

The display unit 26 displays a variety of information, and is constituted by an LCD (liquid crystal display) in the present embodiment. The HDD 28 is a non-volatile storage medium which can rewrite data, and stores map information for representing a road map, surface-of-the-earth pictures, template information, traffic-sign-painted-on-the-road information, and the like registered therein.

The surface-of-the-earth pictures registered in the HDD 28 are some of the pictures among the one registered in the above-mentioned information center 3. That is, in the present embodiment, the pictures are containing the frequently traveling area of the vehicle that has the information storage apparatus, such as the area in the proximity of the user's home.

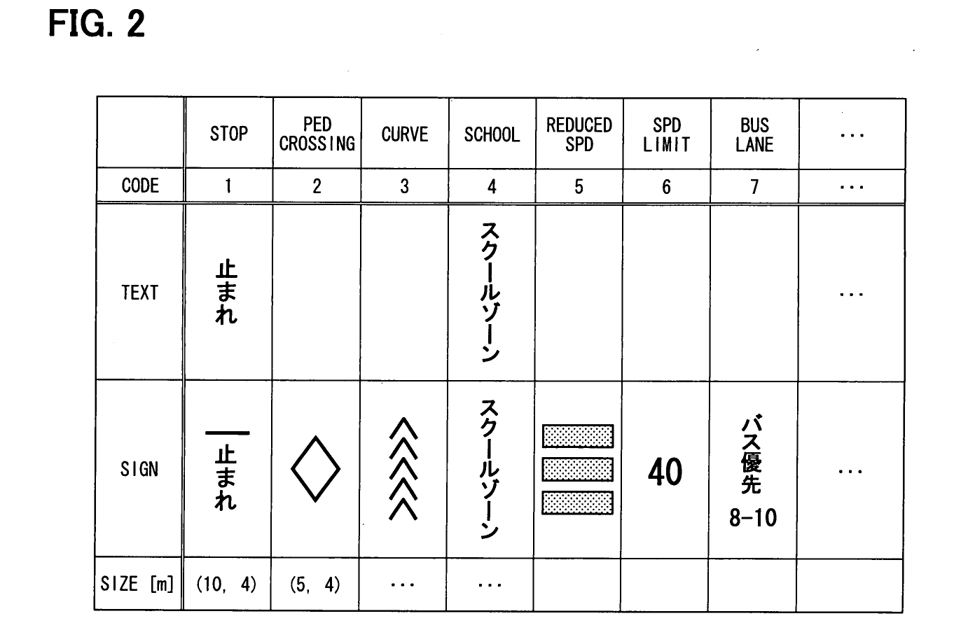

The template information is information used when the control unit 30 recognizes the traffic sign painted on the road regarding a road expressed by the surface-of-the-earth picture, and the template information is, as shown in FIG. 2, for every classification of traffic signs painted on the road, associated with a code showing its meaning, a pattern in the text and the sign painted on a road surface, the size of the pattern on the road surface and the like as registered information. In this case, FIG. 2 is a diagram explaining the template information. The texts and signs use Japanese characters specified in the Japanese traffic regulation. The text and sign corresponding to a code 1 are readable as “Stop,” the text and sign corresponding to a code 4 are readable as “School zone,” and the text corresponding to a code 7 is “Bus lane.” Further, the size of the text/sign pattern is denoted as coordinate format, that is, the size of the text/sign is represented as (x, y) in the x/y directions. The unit of the size is meter.

The traffic-sign-painted-on-the-road information is information showing the traffic sign painted on the road surface. The traffic sign painted on the road existing on the road which has been traveled by the vehicle in the past, among the traffic signs painted on the road expressed by the surface-of-the-earth picture, is registered in the HDD 28 as the traffic-sign-painted-on-the-road information in the present embodiment.

The control unit 30 controls the entire operation of the navigation apparatus 1. That is, the control unit 30 displays the current position specified by GPS receiver 12 on top of the map image around the vehicle in the display unit 26, and performs general guidance processing in which routing assistance to the destination or the like is performed.

Moreover, the control unit 30 recognizes the traffic sign painted on the road (traffic-sign-painted-on-the-road information) of the road on which the vehicle has traveled based on the surface-of-the-earth picture and the template information registered in the HDD 28, and registers the recognized traffic-sign-painted-on-the-road information in association with the position information locating the position of the information in the HDD 28.

Moreover, the control unit 30 computes the instruction value for performing travel control of a slowdown, acceleration and the like of the vehicle, directed to the electrical control unit (i.e., an in-vehicle ECU) 5 which controls an engine, brake mechanism, etc. of the vehicle based on the traffic-sign-painted-on-the-road information registered in the HDD 28.

2. Characteristic Operation of the Car Navigation Equipment 1

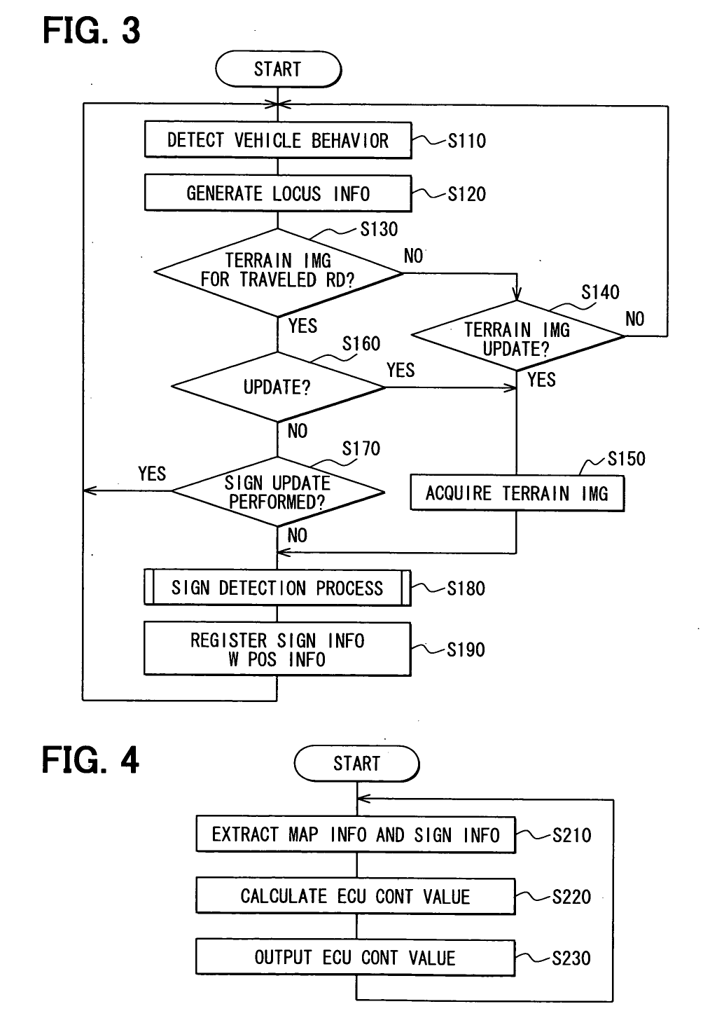

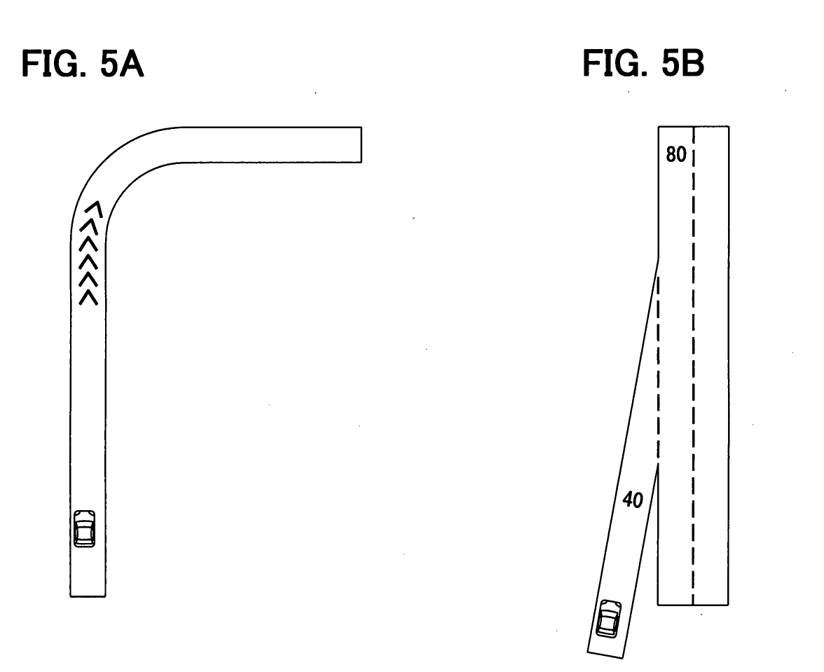

The processing performed in the control unit 30 of the car navigation equipment 1 is hereafter explained using FIGS. 3 to 5. In this case, FIG. 3 is a flow chart showing a traffic-sign-painted-on-the-road information registration processing performed by the control unit 30, FIG. 4 is a flow chart showing a travel control processing performed by the control unit 30, and FIG. 5 is a diagram showing the operation performed in the travel control processing.

2.1. The Traffic-Sign-Painted-on-the-Road Information Registration Processing (Refer to FIG. 3)

The traffic-sign-painted-on-the-road information registration processing shown in FIG. 3 is a processing performed when the engine of the vehicle starts. When the traffic-sign-painted-on-the-road information registration processing is started, based on the detection result by the GPS receiver 12, the speed sensor 14, and the yaw rate sensor 16, the vehicle actions (the current position, the present speed, and the direction of the vehicle etc.) are detected in the first place (S110).

Then, after the detection of the vehicle action, travel locus information that represents the locus of the vehicle's travel is generated based on the detection result (S120). Further, if the length of the locus generated by the processing of S120 reaches a predetermined value, it will be determined, based on the travel locus information, whether the surface-of-the-earth picture including the road (i.e., the locus) where the vehicle has traveled is registered in the HDD 28 (S130).

Then, a selection image for allowing the user to determine whether the surface-of-the-earth picture which includes the road where the vehicle has traveled is acquired from the information center 3 is displayed on the display unit 26 when the surface-of-the-earth picture including the road where the vehicle has traveled is not being registered (S130:NO).

When the acquiring the surface-of-the-earth picture is not chosen by the user (S140:NO), the processing returns to S110. On the other hand, when the acquiring the surface-of-the-earth picture is chosen by the user (S140:YES), through communication performed between the radio communications unit 24 and the information center 3, the surface-of-the-earth picture including the road where the vehicle has traveled is acquired through the information center 3, and the acquired surface-of-the-earth picture is registered (stored) in the HDD 28 (S150).

When the surface-of-the-earth picture acquired from the information center 3 is registered (S150), based on the surface-of-the-earth picture, the travel locus information generated by processing of S120, and the template information, the traffic-sign-painted-on-the-road detection processing in which the traffic sign painted on the road regarding the road where the vehicle has traveled is detected is performed (S180).

More practically, it is, first at S180, based on the travel locus information and the template information, a character pattern and a sign pattern are rotated so that the direction of the vehicle (i.e., the direction in which the vehicle is traveling) and the direction of the character pattern and the sign pattern of the template information (i.e., the upward direction in FIG. 2) match with each other. Then, the traffic sign painted on the road regarding the road where the vehicle has traveled is detected by comparing the character pattern and the sign pattern which rotated, and a surface-of-the-earth picture.

If a traffic sign painted on the road is detected by processing (i.e., the traffic-sign-painted-on-the-road detection processing) of S180, the detection result (i.e., the traffic-sign-painted-on-the-road information) together with the semantic code of the template information corresponding thereto is registered in association with the position information showing the position (i.e., latitude and longitude) where the traffic-sign-painted-on-the-road information is detected (S190), and the processing returns to S110.

Further, when it is determined that the surface-of-the-earth picture including the road where the vehicle has traveled is being registered (S130:YES) by the processing of S130, it is determined whether the surface-of-the-earth picture including the travel locus information which was generated by the processing of S120 has been updated in the information center 3 (S130) based on the communication result derived from communication that is performed between the communication unit 24 and the information center 3.

When it is determined that the update of the surface-of-the-earth information has been performed (S160:YES), the processing proceeds to S150. On the other hand, when it is determined that the update of the surface-of-the-earth picture has not been performed (S160:NO), it is determined whether the traffic-sign-painted-on-the-road detection processing has been already performed regarding the current position of the vehicle specified by the travel locus information generated by the processing of S120 (S170).

When it is determined that the traffic-sign-painted-on-the-road detection processing has not been performed (S170:NO), the processing proceeds to S180 (i.e., the traffic-sign-painted-on-the-road detection processing). When it is determined that the traffic-sign-painted-on-the-road detection processing has been performed (S170:YES), the processing returns to S110.

2.2. Travel Control Processing (Refer to FIG. 4)

The travel control processing shown in FIG. 4 is a processing performed when the engine of the vehicle starts, and if this travel control processing is started, the map information and traffic-sign-painted-on-the-road information around a current position of the vehicle is first extracted from the HDD 28 (S210).

Next, based on a detection result by the map information and traffic-sign-painted-on-the-road information which were extracted at S210, an imaging result by the front camera 22, and a detection result from the millimeter wave radar 20, the control instruction value for making the in-vehicle ECU 5 control the engine, brake mechanism, etc. of the vehicle in a course of travel on a road ahead of the vehicle is computed.

More practically, at S220, the form of the road ahead of the vehicle is detected based on the map information extracted at S210, and, based on an imaging result by the front camera 22, the detection result by the millimeter wave radar 20, and the traffic-sign-painted-on-the-road information extracted in S210, the traffic-sign-painted-on-the-road information, an obstacle, etc. ahead of the vehicle are detected.

Then, based on these detection results, a relative distance, a relative velocity, etc. to a position of the traffic sign painted on the road or the obstacle ahead of the vehicle are calculated, and the quantity of motion (the amount of control) of the vehicle is calculated based on the calculation result. When the quantity of motion of the vehicle is calculated, the above-mentioned control instruction value will be computed based on this quantity of motion.

When the control instruction value is computed by processing of S220, the control instruction value will be outputted to the ECU 5, and the processing will return to S110. By this processing, the ECU 5 performs the travel control of the vehicle according to the control instruction value.

For example, when the traffic-sign-painted-on-the-road information detected in S220 is “curve warning” as shown in FIG. 5A (i.e., the series of upward inequality signs on the road is used, in Japan, to indicate a warning that a curve is ahead), the ECU 5 changes distribution of the driving force in the front rear direction of the vehicle so that the grounding load in a front portion of the vehicle is increased by controlling the engine and brake mechanism. In this manner, the vehicle changes its vehicle travel control mode for the ease of slowing down and turning.

Moreover, when the vehicle are traveling the acceleration lane as shown in FIG. 5B, the ECU 5 changes distribution of the driving force in the front rear direction of the vehicle so that the grounding load in a rear portion of the vehicle increases. This control makes the vehicle easily accelerative. In addition, by controlling the opening-and-closing angle of a throttle valve at this time, the vehicle speed may be controlled not to exceed the traffic-sign-painted-on-the-road information (i.e., the speed limit (refer to FIG. 2)) detected in S220 under the instruction from the ECU 5.

3. Advantage of the Car Navigation Equipment 1 in the Present Embodiment

With the car navigation equipment 1 of the present embodiment, information required for traffic safety is always updated to be in the most up-to-date condition for all roads in the nation because the traffic-sign-painted-on-the-road information which is information required for traffic safety is recognized based on the surface-of-the-earth picture and the recognition result is memorized in the HDD 28.

Moreover, the traffic-sign-painted-on-the-road information to be acquired is information required for traffic safety such as a stop line or a pedestrian crossing. Therefore, by utilizing such traffic-sign-painted-on-the-road information, it can contribute to the traffic safety of the locality while being able to improve the safety of the travel of the vehicle.

Moreover, in the present embodiment, the travel control using the traffic-sign-painted-on-the-road information (i.e., the traffic sign painted on the road) can be used in the vehicle since the present invention is applied to the car navigation equipment 1 carried by the vehicle, and the safety of the travel by the vehicle can be improved.

Further, by using the car navigation equipment 1 in the present embodiment, data volume of the traffic-sign-painted-on-the-road information memorized in the HDD 28 can be decreased compared with the case where all the traffic-sign-painted-on-the-road information is memorized in the HDD 28, since the traffic-sign-painted-on-the-road information which exists in a specific road among the roads expressed by the surface-of-the-earth picture is exclusively memorized in the HDD 28. Therefore, the acquisition of the traffic-sign-painted-on-the-road information is made easy and efficient, and adapting to the change actually happening on the road is also made easy.

Furthermore, in the present embodiment, since the surface-of-the-earth picture pictured from the sky of a road under stable and desirable conditions is used, the traffic-sign-painted-on-the-road information can be acquired without being influenced by conditions such as the weather and time at the moment of the vehicle's travel.

Furthermore, in the present embodiment, the traffic-sign-painted-on-the-road information which is more efficient and useful for the user can be registered by registering (storing) the traffic-sign-painted-on-the-road information on the road where the vehicle driven by the user has traveled.

Furthermore, with the present embodiment, since the engine of the vehicle, control (assistance of operation by a driver) of brake mechanism, etc. are performed according to the traffic sign painted on the road marked by the road ahead of the vehicle, the safety of the vehicle can be raised.

4. Correspondence Between Invention Specific Matter and an Embodiment

In the present embodiment, the HDD 28 is equivalent to the road image storage in claiming language, processing of S180 is equivalent to the traffic sign recognition unit in claiming language, and processing of S190 is equivalent to the traffic sign information storage in claiming language.

### Second Embodiment

Although the information storage apparatus concerning the present invention is applied to the car navigation equipment 1 (i.e., an in-vehicle machine) in the first embodiment, the present embodiment applies the information storage apparatus concerning the present invention to a terminal apparatus used in the information center 3, and to the car navigation equipment 1.

1. Structure of the Information Center 3

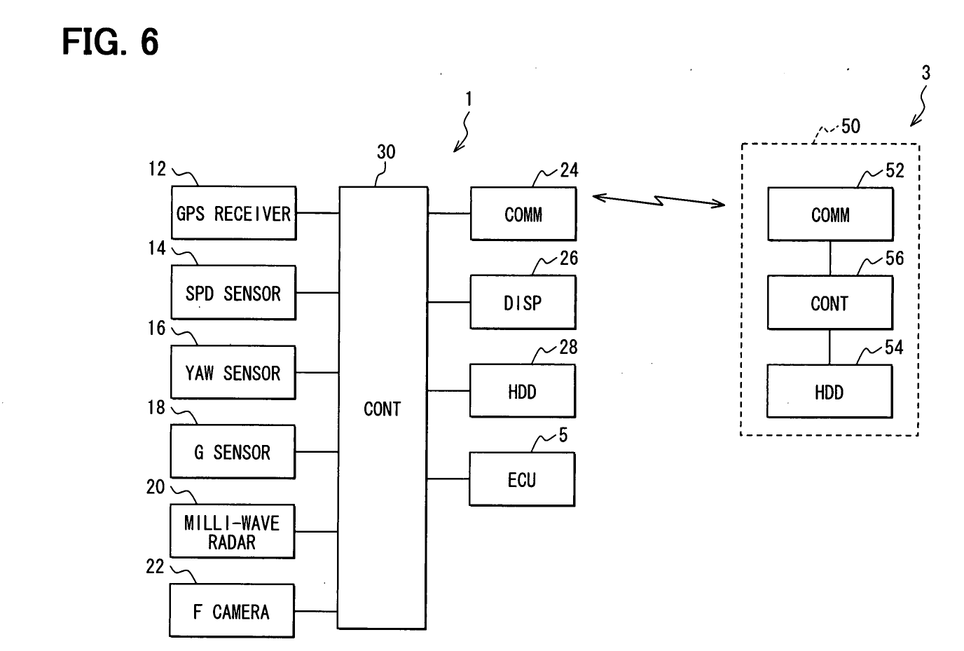

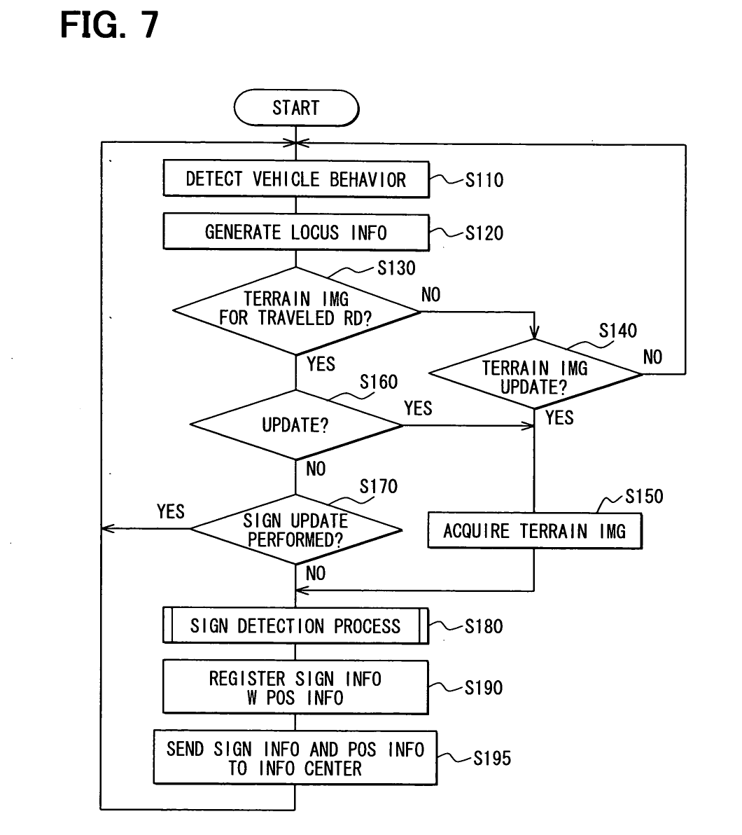

FIG. 6 is a block diagram showing the system structure of the car navigation equipment 1 and the information center 3 concerning the present embodiment. In addition, like parts have like numbers about the same composition as FIG. 1, and detailed explanation of the same composition is omitted. In addition, the same explanation scheme is applied to FIG. 7 that is mentioned later.

A terminal unit 50 which registers and manages the traffic-sign-painted-on-the-road information and the surface-of-the-earth pictures in the nation is installed in the information center 3, and the terminal unit 50 includes a radio communications unit 52 which communicates with the car navigation equipment 1 (i.e., the vehicle) by radio, a HDD 54 as a storage medium which can rewrite data, and a control unit 56 which carries out overall control of the whole equipment.

Further, the HDD 54 registers (i.e., stores) national traffic-sign-painted-on-the-road information in association with the position information, in addition to the surface-of-the-earth pictures registered therein. The control unit 56 registers (i.e., stores), in the HDD 54, the traffic-sign-painted-on-the-road information which the radio communications unit 52 has acquired (i.e., received) from the car navigation equipment 1 based on communication between the radio communications unit 52 and the car navigation equipment 1.

Furthermore, the control unit 56 provides the car navigation equipment 1 with the traffic-sign-painted-on-the-road information on the area requested from the car navigation equipment 1 based on communication between the radio communications unit 52 and the car navigation equipment 1.

2. Characteristic Operations of the Car Navigation Equipment 1 and the Information Center 3

2.1. Characteristic Operations of the Car Navigation Equipment 1

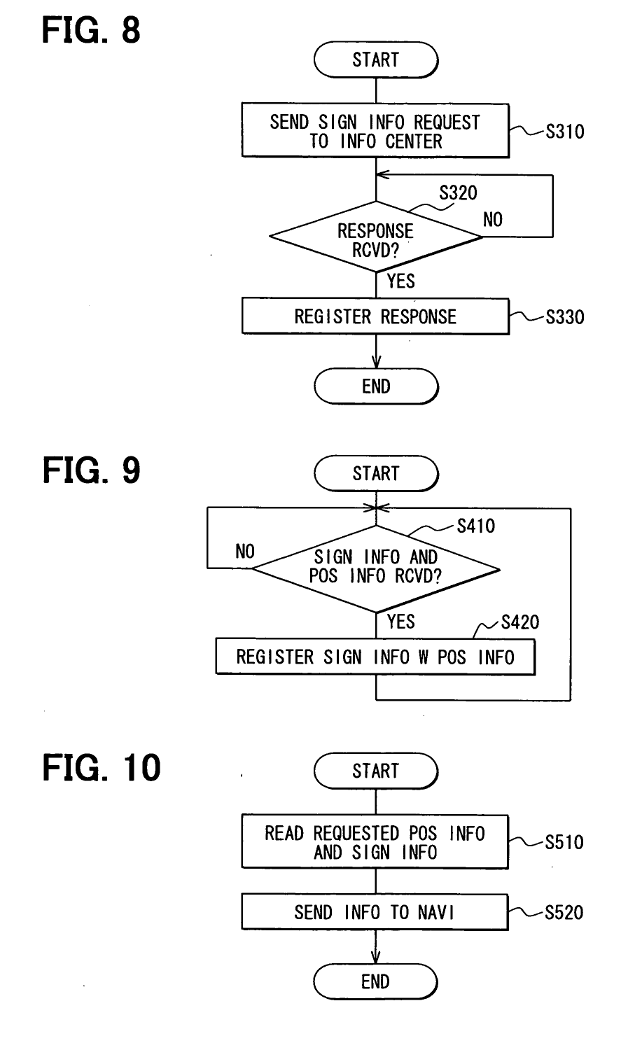

The processing performed in the control unit 30 of the car navigation equipment 1 is hereafter explained using FIGS. 7 and 8. In this case, FIG. 7 is a flow chart showing the traffic-sign-painted-on-the-road information registration processing which the control unit 30 performs, and FIG. 8 is a flow chart showing the traffic-sign-painted-on-the-road information request processing which the control unit 30 performs.

2.1.1. Traffic-Sign-Painted-on-the-Road Information Registration Processing (Refer to FIG. 7)

The traffic-sign-painted-on-the-road information registration processing shown in FIG. 7 is a processing performed when the engine of the vehicle is started. If the traffic-sign-painted-on-the-road information is registered in association with its position (latitude and longitude) by the processing of S190 after the traffic-sign-painted-on-the-road information registration processing is started, the registration contents is transmitted to the terminal unit 50 of the information center 3 through the radio communications unit 24 (S195), and the processing returns to S110.

2.1.2. The Traffic-Sign-Painted-on-the-Road Information Request Processing (Refer to FIG. 8)

The traffic-sign-painted-on-the-road information request processing shown in FIG. 8 is a processing performed when a destination is set up in the car navigation equipment 1. When the traffic-sign-painted-on-the-road information request processing is started, first, the request instructions for acquiring, from the information center 3, the traffic-sign-painted-on-the-road information which exists in a guide route from the present location to the destination are transmitted to the terminal unit 50 of the information center 3 through the radio communications unit 24 by performing communication between the radio communications unit 24 and the information center 3 (S310).

Then, when the request instructions are transmitted to the information center 3 in S310, whether a response corresponding to the request instructions (i.e., the traffic-sign-painted-on-the-road information) has been received by the radio communications unit 24 (S320) is determined. In S320, the processing is performed repeatedly until it is determined that the response corresponding to the request instructions has been received. If it is determined that the response corresponding to the request instructions has been received (S330), the reception result (i.e., the traffic-sign-painted-on-the-road information and the position information showing its position) is registered in the HDD 28 (S330), and the traffic-sign-painted-on-the-road information request processing is completed.

Although, in the traffic-sign-painted-on-the-road information request processing of the present embodiment, the traffic-sign-painted-on-the-road information and the position information showing its position are explained as “a response to the request instructions,” information indicating lack of the traffic-sign-painted-on-the-road information on the guide route is configured to be transmitted from the information center 3 (i.e., the terminal unit 50).

When the information indicating the lack is received by the car navigation equipment 1, it is determined that the response to the request instructions has been received in S320 of the traffic-sign-painted-on-the-road information request processing (S320:YES).

Further, in the traffic-sign-painted-on-the-road information request processing of the present embodiment, when the response to the request instructions is not received for a predetermined period after transmitting the request instructions (S320:NO), the request instructions are re-transmitted. Then, the traffic-sign-painted-on-the-road information request processing is completed if the response to the request instructions is not received even after the number of re-transmission of the request instructions reaches a predetermined value (S320:NO).

2.2. Characteristic Operations of the Information Center 3

The processing performed in the control unit 56 of the information center 3 (i.e., the terminal unit 50) is hereafter explained referring to FIGS. 9 and 10. In this case, FIG. 9 is a flow chart showing the traffic-sign-painted-on-the-road information registration processing which the control unit 56 performs, and FIG. 10 is a flow chart showing the traffic-sign-painted-on-the-road information provision processing which the control unit 56 performs.

2.2.1. The Traffic-Sign-Painted-on-the-Road Information Registration Processing (Refer to FIG. 9)

The traffic-sign-painted-on-the-road information registration processing shown in FIG. 9 is a processing always performed in the control unit 56 of the terminal unit 50. When the traffic-sign-painted-on-the-road information registration processing is started, it is determined first whether the radio communications unit 52 has received the traffic-sign-painted-on-the-road information and the position information from the car navigation equipment 1 (S410).

When it is determined that the traffic-sign-painted-on-the-road information and the position information have not been received (S410:NO), the processing of S410 is repeatedly performed. To the contrary, when it is determined that the traffic-sign-painted-on-the-road information and the position information have been received (S410:YES), the traffic-sign-painted-on-the-road information received by the radio communications unit 52 is associated with the position information similarly received by the radio communications unit 52 to be registered in the HDD 54 (S420), and the processing returns to S410.

2.2.2. The Traffic-Sign-Painted-on-the-Road Information Provision Processing (Refer to FIG. 10)

The traffic-sign-painted-on-the-road information provision processing shown in FIG. 10 is a processing performed when the radio communications unit 52 receives the request instructions from the car navigation equipment 1. When the traffic-sign-painted-on-the-road information provision processing is started, first, the traffic-sign-painted-on-the-road information and its position information corresponding to the request instructions are retrieved from the HDD 54 (S510).

More practically, in S510, the traffic-sign-painted-on-the-road information and the position information which exist in the guide route corresponding to the request instructions among the traffic-sign-painted-on-the-road information and the position information registered in the HDD 54 are retrieved from the HDD 54.

Then, the traffic-sign-painted-on-the-road information and the position information retrieved in S510 are transmitted to the car navigation equipment 1 which has transmitted the request instructions through the radio communications unit 52 (S520), and the traffic-sign-painted-on-the-road information provision processing is completed.

3. Advantage of the Car Navigation Equipment 1 and the Information Center 3

By using the terminal unit 50 of the information center the traffic-sign-painted-on-the-road information and its position information can be managed in a packed manner, thereby enabling a shared use of the information by plural vehicles (i.e., the car navigation equipment 1).

In addition, the terminal unit 50 of the present embodiment may be configured to perform processing which recognizes the traffic-sign-painted-on-the-road information based on the surface-of-the-earth picture (for example, S180 in FIG. 3). In this case, it is preferable to register, in the HDD 54 of the terminal unit 50, the template information mentioned above.

4. Correspondence Relation Between Invention Specific Matter The Embodiment

In the present embodiment, the radio communications unit 24 and the radio communications unit 52 are equivalent to the transmission unit and the reception unit in claiming language, the HDD 28 and the HDD 54 are equivalent to the road image storage in claiming language, and processing of S190, S330, and S420 is equivalent to the road image storage in claiming language.

### Other Embodiments

Although the present invention has been fully described in connection with the preferred embodiment thereof with reference to the accompanying drawings, it is to be noted that various changes and modifications will become apparent to those skilled in the art.

For example, the traffic sign painted on the road marked on the road surface is recognized and registered in the HDD 28 in the above-mentioned embodiment, the operation scheme may be diverted from the above one. That is, the traffic sign information on a raised structure such as a sign post or the like may also be recognized for registration in the HDD 28 under consideration of recognition priority in terms of securing the travel safety of the vehicle.

In addition, although the template information is registered in the HDD 28 beforehand, the present invention is not limited to this scheme. That is, the template information may be acquired from the outside of the vehicle, such as Internet or the like, with the above-mentioned embodiment. In this manner, new template information (traffic sign on the road surface) can be added.

Moreover, although the traffic sign painted on the road regarding the road where the vehicle has traveled in the past is registered in the HDD 28 in the present embodiment, the present invention is not limited to this scheme. That is, a means by which the traffic sign painted on the road in an area of user's preference, that is, the area where the vehicle may possibly travel, may be used for acquiring and storing (registering) the information in the HDD 28.

Moreover, although the surface-of-the-earth picture pictured by the artificial satellite is used with the above-mentioned embodiment, the present invention is not limited to this scheme. That is, the image taken from an airplane may be use as the surface-of-the-earth picture.

Moreover, although the present invention is explained as an application to the car navigation equipment 1 in the above-mentioned first embodiment, the present invention is not limited to this scheme.

Moreover, though in the above-mentioned first embodiment, the information storage apparatus (the car navigation equipment 1) of the present invention is installed in the vehicle, the present invention is not limited to this scheme. That is, the information storage apparatus may not be installed in the vehicle as the terminal unit 50 in the above-mentioned second embodiment.

Moreover, in the above-mentioned embodiment, although the surface-of-the-earth picture is acquired through wireless communications, the present invention is not limited to this scheme. For example, the surface-of-the-earth picture may be acquired from the Internet through the personal computer (PC) installed in a user's home, and the acquired surface-of-the-earth picture may be brought into the car navigation equipment 1 by memory devices, such as a USB memory or the like. In this case, the contact terminal for connecting the memory devices, such as a USB memory, to the car navigation equipment 1 is preferably be prepared.

Although, in the above embodiment, the GPS receiver 12, the speed sensor 14, the yaw rate sensor 16, the G sensor 18, the millimeter wave radar 20, the front camera 22 and the like are prepared in the car navigation equipment 1, the present invention is not limited to this configuration. That is, these components (12-22) may not be disposed in the car navigation equipment 1.

In this case, the GPS receiver 12, the speed sensor 14, the yaw rate sensor 16, the G sensor 18, the millimeter wave radar 20, the front camera 22 and the like may be connected to the car navigation equipment 1 through an in-vehicle network.

Moreover, although travel control of the vehicle is performed by using the traffic-sign-painted-on-the-road information in the above embodiment, the present invention is not limited to this scheme. That is, the present invention may be configured to perform warning control for warning a driver using the traffic-sign-painted-on-the-road information.

Moreover, the present invention may take various forms as long as it pertains to the spirit of the present invention indicated by the appended claims, and should not just be limited to the above-mentioned embodiment.

Such changes and modifications are to be understood as being within the scope of the present invention as defined by the appended claims.

What is claimed is:

1. An information storage apparatus comprising:
a road image storage for storing a road image;
a traffic sign recognition unit for recognizing traffic sign information derived from a traffic sign painted on a road based on the road image stored in the road image storage unit; and
a traffic sign information storage for storing the traffic sign information recognized by the traffic sign recognition unit in association with position information that locates a location of the traffic sign information, wherein
the traffic sign recognition unit recognizes the traffic sign information existing on a road that is expressed by the road image.

2. The information storage apparatus of claim 1, wherein
the road image is an image of a road taken from a sky above the road.

3. The information storage apparatus of claim 1, wherein
the traffic sign recognition unit recognizes the traffic sign existing on the road that is traveled by a vehicle based on the road image stored in the road image storage when the road image storage, the traffic sign recognition unit, and the traffic sign information storage are installed on the vehicle.

4. The information storage apparatus of claim 1 further comprising:
a transmission unit for transmitting the traffic sign information and the position information stored in the traffic sign information storage to an outside of the apparatus; and
a reception unit for receiving the traffic sign information and the position information transmitted from another information storage apparatus, wherein
the traffic sign information storage stores the traffic sign information received by the reception unit in association with the position information received by the reception unit.

5. A travel environment information recognition apparatus comprising:
the information storage apparatus in claim 1; and
a circumstance recognition unit for recognizing a condition and a situation of circumstance of a vehicle based on the traffic sign information stored in the traffic sign information storage.
